(19) United States
(12) Patent Application Publication
(10) Pub. No.: US 2009/0226280 A1
(43) Pub. Date: Sep. 10, 2009

(54) Screw

(76) Inventors: Sebastian Thau, Feldkirch (AT); Peter Hertlein, Loosdorf (AU); Sven Matthiesen, Lindau (DE); Markus Kieber, Schaanwald (LI); Thomas Kistler, St. Gallen (CH)

Correspondence Address: ABELMAN, FRAYNE & SCHWAB, 666 THIRD AVENUE, 10TH FLOOR, NEW YORK, NY, 10017, US

(21) Appl. No.: 12/380,994

(22) Filed: Mar. 5, 2009

(30) Foreign Application Priority Data
Mar. 6, 2008 (DE) 10 2008 000 550.9

(51) Int. Cl. F16B 25/10

(52) U.S. Cl. 411/387.4

(57) ABSTRACT

A screw includes a transition region (12) located between the screw head and the screw stem and having its circumference formed of from three to ten truncated cones (21, 22, 23) following each other in an axial direction and surface lines of which have different inclination angles (α, β, γ) toward the axis (A) which diminish from the head (14) in direction of the tip (13), with a first inclination angle (α) of the surface line of a truncated cone (21) located closest to the head (14) amounting to from 40° to 50°.

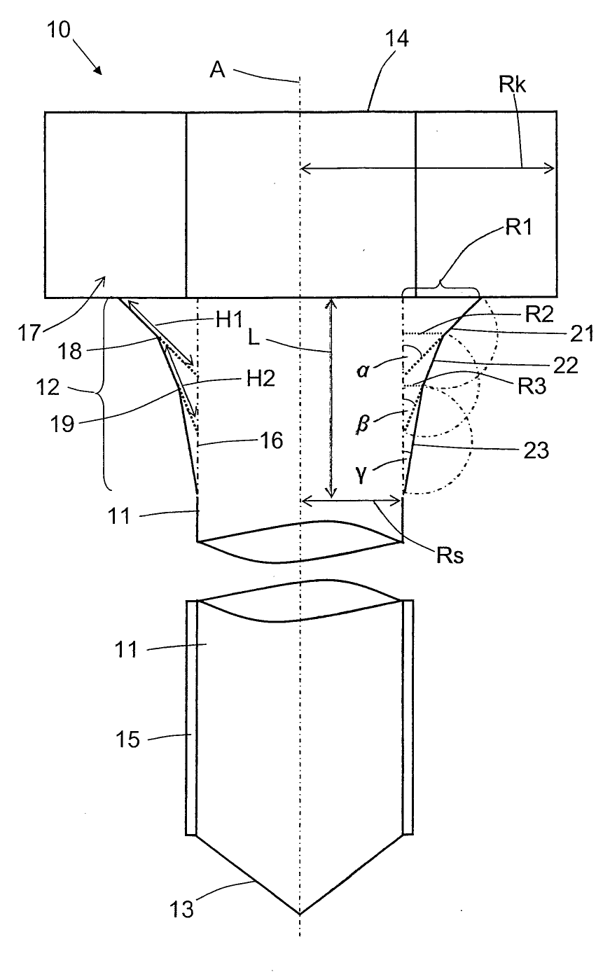

### BACKGROUND OF THE INVENTION

1. Field of the Invention

The present invention relates to a screw having a stem carrying at least in one of its region, a thread and having a stem radium, a tip provided at one end of the stem, a head provided at an opposite end of the stem and a transition region located between the head and the stem.

2. Description of the Prior Art

Screws of the type described above are formed, e.g., as thread-tapping screws and are used, e.g., for screwing of metal sheets. Often, such screws have a head with a diameter that is noticeably greater than the stem diameter. This is the case, e.g., in screws the head of which has polygonal geometry for transmission of rotation from a wrench or a lock mechanism of a power tool. A large difference in diameters between the head and the stem is associated with large loads applied during screwing in of such screws for obtaining a necessary rotational or turning force. The large loads results in very large notch fatigue in the transitional region between the head and the stem. With such screws, there is an increased danger of the head being broken off the stem.

U.S. Pat. No. 3,661,046 discloses a screw of the type discussed above, with a head having a hexagonal geometry as rotation-transmitting means, and a stem adjoining the head. The stem circumferentially carries a thread. In the transition region from the head to the stem, there is provided, from the stem toward the head, a short, extending radially outwardly zone in form of a trumpet. The largest diameter of the trumpet-like zone, in the region closed to the head, only slightly exceeds the stem diameter, whereas the head outer diameter is noticeably greater than the stem diameter.

A drawback of the screw, which is described in the above-mentioned U.S. Patent, consists in that a big jump in the diameter between the head and the stem is associated, as discussed above, with large loads applied, during screwing in of the screw, for obtaining the necessary turning force, which leads to a very large notch fatigue in the transition region between the head and the stem. In this screw, the danger of the head being broken off the stem is rather high.

Accordingly, an object of the present invention is to provide a screw of the type described above in which the above-mentioned drawback of known screws is eliminated.

Another object of the present invention is to provide a screw having a high resistance to breaking of the head of the stem even with a screw head having circumferential rotation-transmitting means the diameter of which exceeds that of the stem.

### SUMMARY OF THE INVENTION

These and other objects of the present invention, which will become apparent hereinafter are achieved, according to the present invention, by providing a screw of the type discussed above and in which the transition region has its circumference formed of from three to ten truncated cones following each other in an axial direction and surface lines of which have different inclination angles toward the axis which diminish from the head in direction of the tip, with a first inclination angle of the surface line of a truncated cone located closest to the head, amounting to from 40° to 50°.

The transition region between the head and stem of a screw and which is formed according to the present invention permits to noticeably reduce the notch stress in this region, whereby the resistance to the head breaking off the stem is greatly increased.

In the inventive screw, preferably, the first inclination angle amounts to 45°.

Advantageously, an inclination angle of a surface line of a truncated cone following, in the axial direction toward the tip, an immediately adjacent, toward the head, truncated cone, amounts to n-times of the inclination angle of the surface line of the immediately adjacent truncated cone, and wherein n is equal to a number between 0.45 and 0.55. It is particularly advantageous when n is equal to 0.5.

Advantageously, the first truncated cone has, at an end thereof adjacent to the head, a maximal first radial width with respect to the stem that is smaller or equal to a difference between the minimal head radius and the stem radius according to equation

first radial width≦Head Radius−Stem Radius

With the first radial width according to this equation, a noticeable reduction of the notch fatigue is achieved.

It is advantageous, when the first radial width of the first truncated cone corresponds to from 40% to 80% of the difference between the minimal head radius and the stem radius. With this, a certain underhead surface will remain and which both brakes the screw against the sheet metal to actuate the safety clutch of the screw driving tool, and prevents the pulling of the screw through a sheet(s).

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

In the Drawings:

Single FIGURE shows a front elevational view of a thread-tapping screw according to the present invention.

### DETAILED DESCRIPTION OF THE PREFERRED EMBODIMENT

A thread-tapping screw 10 according to the present invention, which is shown in the drawings, has a stem 11 carrying a thread 15 and provided with a tip 13 at one of its end and a head 14 at the opposite end. An axis A defines an axial direction of the screw 10. The head 14 has a rotation-transmitting element 17 for a screw-driving tool and having its outer surface formed as a polygon, in particular, as a hexagon that can be engaged by a wrench.

Between the head 14 and the stem 11, there is provided a transition section 12 having a reinforced geometry in comparison with the stem 11. The transition section 12 is formed by three truncated cones 21, 22, 23 following each other in the axial direction.

A surface line of the first truncated cone 21, which is most adjacent to the head 14, has an inclination angle α toward the axis A in a range between 40° and 50° and, preferably of 45° (for clarity sake, in the drawing, the inclination angle α is shown with respect to a projection 16 of the stem 11 and which extends parallel to the axis A). The surface line is a line on a cone outer surface of a respective truncated cone extending in the axial direction. The inclination angle β, γ of the surface lines of the truncated cones 22, 23, which follow the first truncated cone 21 in the axial direction, is reduced toward the tip 13. The truncated cone 22, 23, which is closer to the tip 13, has the inclination angle β, γ of the surface line that amounts to n-times of the inclination angle α, β of the surface line of the truncated cone 21, 22 adjacent to that truncated cone 22, 23 on the side of the head 14. n is a number between 0.45 and 0.55. In the embodiment shown in the drawings, the inclination angle β of the surface line of the second truncated cone toward the axis A, i.e., toward the projection 16 amounts to 0.5 of the inclination angle α of the first truncated cone 21. Thus, the inclination angle β amounts to between 20° and 25°, preferably, to 22.5°. The inclination angle γ of the surface line of the third truncated cone 23 toward the axis A or the projection 16 amounts to 0.5 of the inclination angle β of the surface line of the second truncated cone 22 or to 0.25 of the inclination angle α of the surface line of the first truncated cone 21. Thus, the inclination angle γ amounts to between 10 and 12.5°, preferably, to 11.5°. The inclination angle α, β, γ are, thus, reduced from the region adjacent to the head 14 in the direction of the tip 13 in a step-like manner.

The first truncated cone 21 has at its end adjacent to the head 14 a maximal first radial width R1 (starting from the projection 16 of the stem 11) which smaller or equal to the difference between a minimal head radius Rₖ (i.e., head radius between the longitudinal axis of the screw and a closest, to this longitudinal axis, outer surface of the head) and the stem radius Rₛ, according to an equation

R1≦Rₖ−Rₛ

The first radial width R1 of the first truncated cone 21 corresponds to from 40% to 80% (or to 0.4-0.8) of the difference between the minimal head radius Rₖ and the stem radius Rₛ. The maximal radial width R2 of the second truncated cone 22 (in the transition region to the first truncated cone 21) corresponds to from 0.4 to 0.8, preferably, to 0.5 of the first radial width R1. A maximal third radial width R3 of the third truncated cone 23 (in the transition region to the second truncated cone 22) corresponds to from 0.45 to 0.55, preferably, 0.5 of the second radial width R2.

The second truncated cone 22 is so arranged with respect to the first truncated cone 21 that it branches from the first truncated cone 21 at a point 18 that lies on a half of an interpolated length H1 of the surface line of the first truncated cone 21 toward the projection 16 of the stem 11. The third truncated cone 23 is likewise so arranged with respect to the second truncated cone 22 that it branches from the second truncated cone 22 at a point 19 that lies on a half of an interpolated length H2 of the surface line of the second truncated cone 22 toward the projection 16 of the stem 11.

The transitional region 12, which is formed by the truncated cover 21, 22, 23, extends axially over a length L. The length L can be calculated for an ideal inclination angle, with the inclination angle α of the surface line of the first truncated cone 21 being equal 45%, according to formula

L=R1*X

where X is a variable constant dependent on the number of truncated cones and an have the following values:
X=1 for one truncated cone, X=1.70711 for two truncated cones, X=2.36039 for three truncated cones, X=3.00112 for four truncated cones, X=3.63876; X=4.27564 for six truncated cones, X=4.91232 for seven truncated cones, X=5.54896 for eight truncated cones, X=6.18558 for nine truncated cones, and X=6.82220 for ten truncated cones.

In order to prevent friction, the screw 10 can be provided, at least in the region of the thread 15 and/or the tip 13 with a friction-preventing coating such as, e.g., organic (e.g., wax or cutting oil) or inorganic lubricant (e.g., zinc).

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A screw (10), comprising a stem (14) carrying at least in one region thereof, a thread (15) and having a stem radium (Rₛ); a tip (13) provided at one end of the stem (11); a head (14) provided at an opposite end of the stem (11) and having a minimal head radius (Rₖ); and a transition region (12) located between the head (14) and the stem (11), the transition region (12) having a circumference thereof formed of from three to ten truncated cones (21, 22, 23) following each other in an axial direction and surface lines of which have different inclination angles (α, β, γ) toward the axis (A) which diminish from the head (14) in direction of the tip (13), with a first inclination angle (α) of the surface line of a truncated cone (21) located closest to the head (14) amounting to from 40° to 50°.

2. A screw according to claim 1, wherein an inclination angle (β, γ) of a surface line of a truncated cone (22, 23) following, in the axial direction toward the tip (13), an immediately adjacent, toward the head (14), truncated cone (21, 22) amounts to n-times of the inclination angle (α, β) of the surface line of the immediately adjacent truncated cone (21, 22), and wherein n is equal to a number between 0.45 and 0.55.

3. A screw according to claim 2, wherein n is equal to 0.5.

4. A screw according to claim 1, wherein the first truncated cone (21) has, at an end thereof adjacent to the head (14), a maximal first radial width (R1) with respect to the stem (11) that is smaller or equal to a difference between the minimal head radius (Rₖ) and the stem radius (Rₛ) according to equation:
R1≦Rₖ−Rₛ.

5. A screw according to claim 4, wherein the first radial width (R1) of the first truncated cone (21) corresponds to from 40% to 80% of the difference between the minimal head radius (Rₖ) and the stem radius (Rₛ)
